(19) United States
(12) Patent Application Publication
(10) Pub. No.: US 2023/0129133 A1
(43) Pub. Date: Apr. 27, 2023

(54) HIERARCHICAL COARSE-GRAIN SPARSITY FOR DEEP NEURAL NETWORKS

(71) Applicants: Jae-sun Seo, Tempe, AZ (US); Deepak Kadetotad, Tempe, AZ (US); Chaitali Chakrabarti, Tempe, AZ (US); Visar Berisha, Tempe, AZ (US)

(72) Inventors: Jae-sun Seo, Tempe, AZ (US); Deepak Kadetotad, Tempe, AZ (US); Chaitali Chakrabarti, Tempe, AZ (US); Visar Berisha, Tempe, AZ (US)

(73) Assignee: Arizona Board of Regents on behalf of Arizona State University, Scottsdale, AZ (US)

(21) Appl. No.: 18/047,374

(22) Filed: Oct. 18, 2022

Related U.S. Application Data
(60) Provisional application No. 63/257,011, filed on Oct. 18, 2021.

(51) Int. Cl. G06N 3/08

(52) U.S. Cl. CPC G06N 3/08

(57) ABSTRACT

Hierarchical coarse-grain sparsity for deep neural networks is provided. An algorithm-hardware co-optimized memory compression technique is proposed to compress deep neural networks in a hardware-efficient manner, which is referred to herein as hierarchical coarse-grain sparsity (HCGS). HCGS provides a new long short-term memory (LSTM) training technique which enforces hierarchical structured sparsity by randomly dropping static block-wise connections between layers. HCGS maintains the same hierarchical structured sparsity throughout training and inference; this reduces weight storage for both training and inference hardware systems.

### CROSS-REFERENCE TO RELATED APPLICATIONS

This application claims priority to U.S. Provisional Application No. 63/257,011, filed on Oct. 18, 2021, incorporated herein by reference in its entirety.

### FIELD OF THE DISCLOSURE

The present disclosure relates to machine learning, and more particularly to accelerating neural networks.

### BACKGROUND

The emergence of Internet-of-Things (IoT) devices, which require edge computing with severe area/energy constraints, has garnered substantial interest in energy-efficient application-specific integrated circuits (ASIC) accelerators for deep learning applications. Automatic speech recognition (ASR) is one of the most prevalent tasks that allow such edge devices to interact with humans and have been integrated into many commercial edge devices.

Recurrent neural networks (RNNs) are very powerful for speech recognition, combining two properties: 1) a distributed hidden state that allows them to store a lot of information about the past efficiently and 2) non-linear dynamics that allow them to update their hidden state in complicated ways. Long short-term memory (LSTM) is a type of RNN with internal gates to scale the inputs and outputs within the cell. LSTM gates avoid the vanishing/exploding gradients issue that plagues RNNs, but they require 8× weights compared with a multi-layer perceptron (MLP) that has the same number of hidden neurons per layer.

Due to the large size of the LSTM RNNs that enable accurate ASR, most of these speech recognition tasks are performed in cloud servers, which requires a constant internet connection, involves privacy concerns, and incurs latency for speech recognition tasks. A particular challenge of performing on-device ASR is that state-of-the-art LSTM-based models for ASR contain tens of millions of weights. Weights can be stored on-chip (e.g., SRAM cache of mobile processors), which has fast access time (nanoseconds range) but is limited to a few megabytes (MBs) due to cost. Alternatively, weights can be stored off-chip (e.g., DRAM) up to a few gigabytes (GBs), but access is slower (tens of nanoseconds range) and consumes ˜100× higher energy than on-chip counterparts.

To improve the energy efficiency of neural network hardware, off-chip memory access and communication need to be minimized. To that end, it becomes crucial to store most or all weights on-chip through sparsity/compression, weight quantization, and network size reduction. Recent works presented methods to reduce the complexity and memory requirements of RNNs for ASR.

### SUMMARY

Hierarchical coarse-grain sparsity for deep neural networks is provided. An algorithm-hardware co-optimized memory compression technique is proposed to compress deep neural networks in a hardware-efficient manner, which is referred to herein as hierarchical coarse-grain sparsity (HCGS). HCGS provides a new long short-term memory (LSTM) training technique which enforces hierarchical structured sparsity by randomly dropping static block-wise connections between layers. HCGS maintains the same hierarchical structured sparsity throughout training and inference; this reduces weight storage for both training and inference hardware systems.

Aided by HCGS-based block-wise recursive weight compression, LSTM recurrent neural networks are demonstrated with up to 16× fewer weights while achieving minimal error rate degradation. The prototype chip fabricated in 65 nanometer (nm) low-power (LP) complementary metal-oxide-semiconductor (CMOS) achieves up to 8.93 tera-operations per second per watt (TOPS/W) for real-time speech recognition using compressed LSTMs based on HCGS. HCGS-based LSTMs have demonstrated energy-efficient speech recognition with low error rates for TIMIT, TED-LIUM, and LibriSpeech data sets.

An exemplary embodiment provides a method for compressing a neural network. The method includes randomly selecting a hierarchical structure of block-wise weights in the neural network and training the neural network by selecting a same number of random blocks for every block row.

Another exemplary embodiment provides a neural network accelerator. The neural network accelerator includes an input buffer, an output buffer, and a hierarchical coarse-grain sparsity selector configured to randomly select block-wise weights from the input buffer for training a neural network.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a graphical representation comparing index memory overhead of the HCGS scheme with two compression methods: simple coordinate (COO) and compressed sparse column (CSC).

FIG. 2 is a diagram of computation flow for each layer of an LSTM, which is a specialized recurrent structure.

FIG. 3 is a schematic block diagram of LSTM RNN weight compression according to embodiments of the HCGS described herein.

FIG. 4 illustrates an example binary connection matrix for two levels of HCGS.

FIG. 5 is a graphical representation of HCGS design space exploration of two-layer LSTM RNNs across different RNN widths and number of CGS levels.

FIG. 6 is a graphical representation of a weight precision investigation with HCGS-based compression for 512-cell two-layer LSTM RNNs.

FIG. 7 is a graphical representation of robustness of HCGS performance across various block sizes and random block selection.

FIG. 8 is a graphical representation of further reduction of index memory aided by using the same random block selection for four gates in each LSTM layer.

FIG. 9 is a schematic diagram of the overall architecture of the proposed LSTM accelerator.

FIG. 10 illustrates a timing diagram of LSTM computation and the necessary interleaved storage pattern of weights in on-chip SRAMs.

FIG. 11 illustrates a chip micrograph of an evaluated embodiment along with a performance summary.

FIG. 12 illustrates example speech recognition results and the transcribed text for the TED-LIUM data set.

FIG. 13A is a graphical representation of power and frequency measurement results with voltage scaling for two-layer LSTM for the TIMIT data set.

FIG. 13B is a graphical representation of power and frequency measurement results with voltage scaling for three-layer LSTM for the TED-LIUM data set.

FIG. 13C is a graphical representation of power and frequency measurement results with voltage scaling for three-layer LSTM for the LibriSpeech data set.

FIG. 14 is a graphical representation of measurement results of energy efficiency (TOPS/W) and leakage power of two-layer LSTM for TIMIT data set.

FIG. 15 is a graphical representation of the memory and logic power breakdown for the three-layer RNN at 0.75-V supply.

FIG. 16 is a graphical representation comparing the TIMIT PER and frames/second/power (FPS/W) of the proposed HCGS and prior works that perform speech/phoneme recognition.

FIG. 17 is a graphical representation comparing PER (TIMIT) between the multi-tier HCGS scheme and a single-tier CGS scheme.

FIG. 18 is a graphical representation of PER vs. RNN weight memory results for various 2-layer LSTMs for TIMIT.

FIG. 19 is a graphical representation of WER vs. RNN weight memory results for various 3-layer LSTMs for TED-LIUM.

FIG. 20 is a graphical representation of a PER (TIMIT) comparison between HCGS and learned sparsity methods.

FIG. 21 compares the total RNN weight memory and PER for prior LSTM works with structured compression and a baseline uncompressed LSTM, with the Pareto front curve obtained with the proposed HCGS-based LSTMs.

FIG. 22 is a computing device the disclosed system may operate on according to aspects of the present invention.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Hierarchical coarse-grain sparsity for deep neural networks is provided. An algorithm-hardware co-optimized memory compression technique is proposed to compress deep neural networks in a hardware-efficient manner, which is referred to herein as hierarchical coarse-grain sparsity (HCGS). HCGS provides a new long short-term memory (LSTM) training technique which enforces hierarchical structured sparsity by randomly dropping static block-wise connections between layers. HCGS maintains the same hierarchical structured sparsity throughout training and inference; this reduces weight storage for both training and inference hardware systems.

Aided by HCGS-based block-wise recursive weight compression, LSTM recurrent neural networks are demonstrated with up to 16× fewer weights while achieving minimal error rate degradation. The prototype chip fabricated in 65 nanometer (nm) low-power (LP) complementary metal-oxide-semiconductor (CMOS) achieves up to 8.93 tera-operations per second per watt (TOPS/W) for real-time speech recognition using compressed LSTMs based on HCGS. HCGS-based LSTMs have demonstrated energy-efficient speech recognition with low error rates for TIMIT, TED-LIUM, and LibriSpeech data sets.

I. Introduction

Long short-term memory (LSTM) is a type of recurrent neural network (RNN), which is widely used for time-series data and speech applications, due to its high accuracy on such tasks. However, LSTMs pose difficulties for efficient hardware implementation because they require a large amount of weight storage and exhibit computation complexity. Prior works have proposed compression techniques to alleviate the storage/computation requirements of LSTMs. Magnitude-based pruning has shown large compression, but the index storage can be a large burden, especially for the simple coordinate (COO) format that stores each nonzero weight's location. The compressed sparse row/column (CSR/CSC) format reduces the index cost as only the distance between non-zero elements in a row/column is stored, but still requires non-negligible index memory and causes irregular memory access.

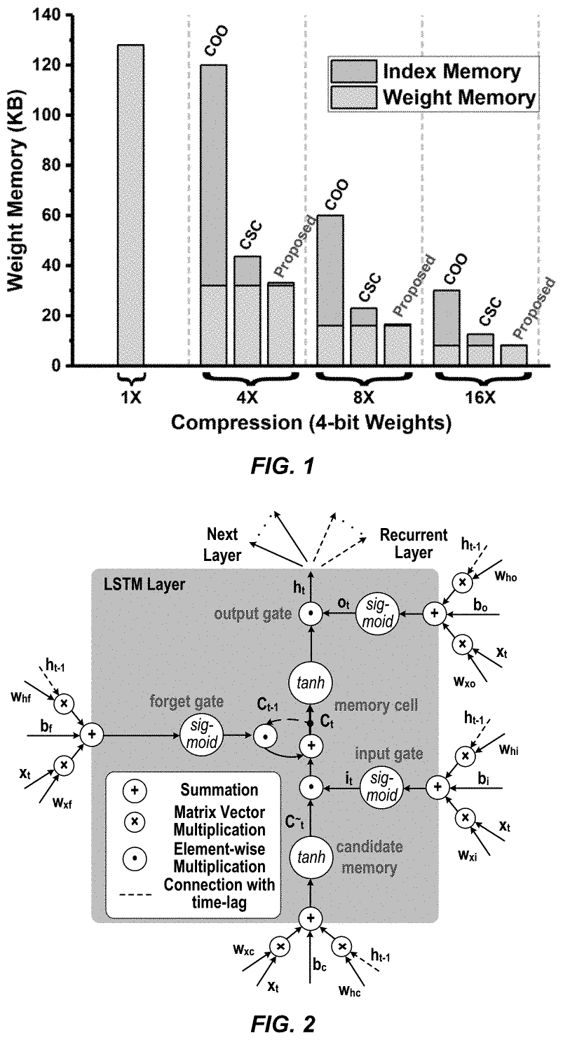

A new HCGS scheme is presented herein that structurally compresses LSTM weights by 16× with minimal error rate degradation. FIG. 1 is a graphical representation comparing index memory overhead of the HCGS scheme with the two aforementioned compression methods: COO and CSC. The comparison is made between these approaches for a 512×512 weight matrix with 4-bit weight precision for compression targets from 1× (dense network) to 16× (6.25% of weights are non-zero). Embodiments of HCGS provide hierarchical block-wise sparsity for weight matrices in LSTMs, which substantially reduces the index overhead to <1.3%.

An HCGS-based LSTM accelerator is prototyped in 65-nm LP CMOS, which executes two-/three-layer LSTMs for real-time speech recognition. It consumes 1.85-/3.43-/3.42-mW power and achieves 8.93/7.22/7.24 TOPS/W for TIMIT/TED-LIUM/LibriSpeech data sets, respectively. Contributions of this disclosure include the following:
1) A novel hierarchical block-wise sparsity scheme is proposed and applied to LSTM RNNs, which shows favorable error rate and memory compression tradeoffs compared with prior works.
2) Beyond simpler TIMIT data set, the LSTM accelerator is benchmarked against larger-scale TED-LIUM and LibriSpeech data sets with low error rates, demonstrating practical feasibility.
3) Aided by 16×HCGS compression and with 6-bit weight quantization, all parameters of LSTMs for TIMIT/TED-LIUM/LibriSpeech are stored on-chip in <300-kB SRAM.

Section II presents the proposed HCGS algorithm for LSTMs. Section III describes the HCGS-based LSTM accelerator architecture and chip design optimization. In Section IV, the prototype chip measurement results and comparison are presented.

II. LSTM and Hierarchical Coarse-Grain Sparsity

A. LSTM-Based Speech Recognition

LSTM RNNs have shown state-of-the-art accuracy for speech recognition tasks. FIG. 2 is a diagram of computation flow for each layer of an LSTM, which is a specialized recurrent structure. Each layer of an LSTM consists of neurons, which computes the final output hₜ through four intermediate results called gates. In addition to the hidden state hₜ used as a transient representation of state at timestep t, LSTM introduces a memory cell cₜ, intended for internal long-term storage. The parameters cₜ and hₜ are computed via input, output, and forget gate functions. The forget gate function ƒₜ directly connects cₜ to the memory cell cₜ₋₁ of the previous timestep via an element-wise multiplication. Large values of the forget gates cause the cell to remember most (if not all) of its previous values. Each gate function has a weight matrix and a bias vector; subscripts i, o, and ƒ are used to denote parameters for the input, output, and forget gate functions, respectively. For example, the parameters for the forget gate function are denoted as W_{xƒ}, W_{hƒ}, and b_{ƒ}.

With the abovementioned notations, an LSTM is defined as:

iₜ=σ(Wₓᵢxₜ+Wₕᵢhₜ₋₁+bᵢ) Equation 1

ƒₜ=σ(W_{xƒ}xₜ+W_{hƒ}hₜ₋₁+b_{ƒ}) Equation 2

oₜ=σ(Wₓₒxₜ+Wₕₒhₜ₋₁+bₒ) Equation 3

\tilde{c}ₜ=tanh(W_{xc}xₜ+W_{hc}hₜ₋₁+b_{c}) Equation 4

cₜ=ƒₜ⊙cₜ₋₁+iₜ⊙\tilde{c}ₜ Equation 5

hₜ=oₜ⊙tanh(cₜ) Equation 6

where σ(⋅) represents the sigmoid function and ⊙ is the element-wise product. From the abovementioned LSTM equations, the weight memory requirement of LSTMs is 8× compared with MLPs with the same number of neurons per layer. The LSTM-based speech recognition typically consists of pipeline of a pre-processing or feature extraction module, followed by an LSTM RNN engine and then by a Viterbi decoder. A commonly used feature for pre-processing of speech data is feature-space maximum likelihood linear regression (fMLLR). fMLLR features are extracted from Mel frequency cepstral coefficients (MFCCs) features, obtained conventionally from 25-ms windows of audio samples with 10-ms overlap between adjacent windows. The features for the current window are combined with those of past and future windows to provide the context of input speech data. In an exemplary implementation, five past windows, one current window, and five future windows are merged to generate an input frame with 11 windows, leading to a total of 440 fMLLR features per frame. These merged sets of features become inputs to the ensuing LSTM RNN. The output layer of the LSTM consists of probability estimates that are conveyed to the subsequent Viterbi decoder module to determine the best sequence of phonemes/words.

B. Hierarchical Coarse-Grain Sparsity (HCGS)

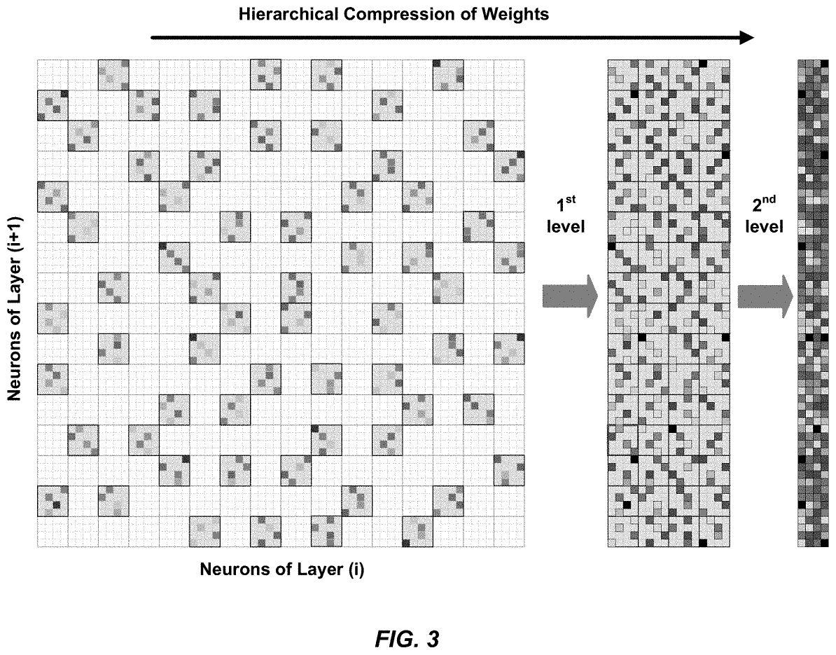

FIG. 3 is a schematic block diagram of LSTM RNN weight compression according to embodiments of the HCGS described herein. The proposed HCGS scheme maintains coarse-grain sparsity while further allowing fine-grain weight connectivity, leading to significant energy and area reduction. FIG. 3 illustrates a two-level HCGS, where the first level compresses weights (e.g., 4× compression) using a larger block size (e.g., 32×32), and the remaining weights in the large blocks go through the second level of compression (e.g., 4×) with a smaller block size (e.g., 8×8). Beyond two levels, the HCGS hierarchy can be expanded to have multiple levels of block-wise sparse structure, recursively selecting even smaller blocks within smaller blocks (e.g., three-level and four-level HCGSs).

The hierarchical structure of block-wise weights is randomly selected before the RNN training process starts, and this pre-defined structured sparsity is maintained throughout the training and inference phases. A constraint is applied such that HCGS always selects the same number of random blocks for every block row (see FIG. 3); hence, the selected blocks fit efficiently in SRAMs, enhancing regular memory access and hardware acceleration. The unselected blocks remain at zero and do not contribute to the physical memory footprint during both training and inference. While this disclosure focuses on the HCGS-based LSTM inference accelerator, due to the pre-defined and static nature of HCGS-based sparsity training hardware acceleration could also become more efficient with significantly fewer weights and computation involved for the training process of deep neural networks.

In HCGS, the connections between feed-forward layers and recurrent layers are dropped in a hierarchical and recursive block-wise manner. The example shown in FIG. 3 has a two-tier hierarchy, where the first tier connections are dropped randomly in large blocks (i.e. grey blocks). Within the preserved connections in the first tier (grey blocks), the second tier connections are then dropped randomly in smaller colored blocks to achieve further sparsity. Only the weights that are preserved through both tiers of hierarchy are trained and employed for inference. This random block selection is stored in a connection mask (C^{W} or C^{U} in Algorithm 1) at the start of training and fixed throughout training. The connection mask only contains 0s and 1s, where 0s signify the deleted connections and 1s represent the preserved block-wise connections.

The indices needed for HCGS networks in FIG. 3 also have two tiers. The first tier index stores the location of the grey block within the weight matrix, and the second tier index represents the smaller block's location within the larger grey block. The HCGS hierarchy can be expanded to have multiple tiers of block-wise sparse structure, recursively selecting even smaller blocks within smaller blocks.

Algorithm 1 Training LSTM with HCGS. ○ indicates element-wise
multiplication, C is the cost function for a minibatch, λ is the learning
rate decay factor, and L is the number of layers.

```
Require: a minibatch of inputs and targets (x, a*), previous weights W
and U, HCGS mask C^{W} and C^{U} as well as previous learning rate η.
Ensure: updated weights W^{t+1} and U^{t+1} and updated learning rate η^{t+1}.
Forward Propagation:
for k = 1 to L do
  ${W}_{{k}_{i , f , o , c}} ← {W}_{{k}_{i , f , o , c}} ∘ {C}_{k}^{W}$
  ${U}_{{k}_{i , f , o , c}} ← {U}_{{k}_{i , f , o , c}} ∘ {C}_{k}^{U}$
  ${h}_{k , t} ← Compute ( {W}_{{k}_{i , f , o , c}} , {U}_{{k}_{i , f , o , c}} , {x}_{k , t} ) \{ via ( 1 ) - ( 5 ) \}$
  x_{k+1,t} ← h_{k,t}
end for
Backward Propagation:
${g}_{{W}_{{k}_{i , f , o , c}}} and {g}_{{U}_{{k}_{i , f , o , c}}} are the gradients calculated for each$
layer k from 1 to L and are represented below as g_{W}_{ₖ} and g_{U}_{ₖ}
$respectively for simplicity . Similarly {W}_{{k}_{i , f , o , c}} and {U}_{{k}_{i , f , o , c}}$
are represented as Wₖ and Uₖ.
Parameter Update:
for k = 1 to L do
  g_{W}_{ₖ} ← g_{W}_{ₖ} ○ Cₖ^{W}
  Wₖ^{t+1} ← Update(Wₖ, η, g_{W}_{ₖ})
  g_{U}_{ₖ} ← g_{U}_{ₖ} ○ Cₖ^{U}
  Uₖ^{t+1} ← Update(Uₖ, η, g_{U}_{ₖ})
  η^{t+1} ← λη
end for
```

Algorithm 1 shows the computational changes required to incorporate HCGS in LSTM training. The binary connection mask is initialized for every layer of the feed-forward network (C^{W}) and the recurrent network (C^{U}), which forces the deleted weight connections to zero during the forward propagation. During back-propagation, the HCGS mask ensures that the deleted weights do not get updated and remain zero throughout training.

To further increase compression efficiency, weights associated with the four gates in each LSTM layer share the common connection mask that is randomly selected. Sharing the same random mask results in 4× reduction of the index memory, and reduces the computations for decompression by 4× as well.

Compared to cases where different random masks were used for the four gates, sharing the same random mask did not affect PER or WER by more than 0.2% across all LSTM evaluations.

Three well-known benchmarks for speech recognition applications, TIMIT, TED-LIUM, and LibriSpeech, are used to train the proposed HCGS-based LSTMs and evaluate the corresponding error rates. The baseline three-layer, 512-cell LSTM RNN that performs speech recognition for TED-LIUM/LibriSpeech data sets requires 24 MB of weight memory in floating-point precision. Aided by the proposed HCGS that reduces the number of weights by 16× and low-precision (6-bit) representation of weights, the compressed parameters of a three-layer, 512-cell LSTM RNN is reduced to only 288 kB (83× reduction in model size compared with 24 MB). The resultant LSTM network can be fully stored on-chip, which enables energy-efficient acceleration without costly DRAM access.

C. HCGS-Based Training

LSTM RNNs are trained by minimizing the cross-entropy error, as described in the following equation:

E=−Σᵢ₌₁^{N}tᵢ×lnyᵢ Equation 7

where N is the size of the output layer, yᵢ is the ith output node, and tᵢ is the ith target value or label. The mini-batch stochastic gradient method is used to train the network. The change in weight for each iteration is the differential of the cost function with respect to the weight value, as follows:

$$Δ W = \frac{δ E}{δ W} \qquad Equation 8$$

The weight Wᵢⱼ in the (k+1)th iteration is updated using the following equation:

(Wᵢⱼ)ₖ₊₁=(Wᵢⱼ)ₖ+{(ΔWᵢⱼ)ₖ+m×(ΔWᵢⱼ)ₖ₋₁}×lr×Cᵢⱼ Equation 9

where m is the momentum, lr is the learning rate, and Cᵢⱼ is the binary connection coefficient between two subsequent neural network layers, which is introduced for the proposed HCGS, and only the weights in the network corresponding to Cᵢⱼ=1 are updated.

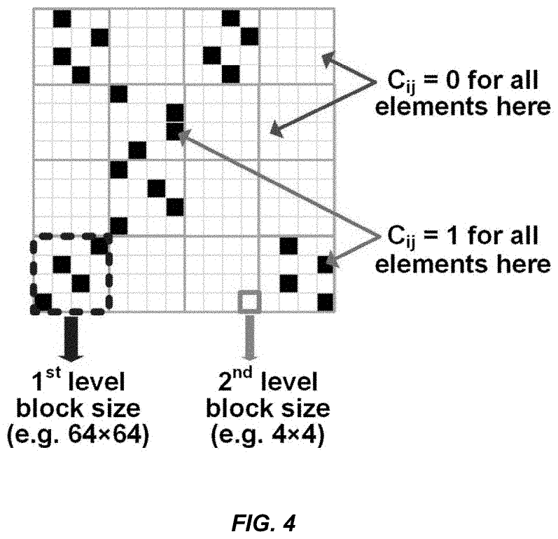

FIG. 4 illustrates an example binary connection matrix (Cᵢⱼ matrix) for two levels of HCGS. Since existing neural network training frameworks (e.g., PyTorch and TensorFlow) cannot efficiently support this type of hierarchical block-wise structure, updating the non-selected weights from pre-defined sparsity is prevented by setting Cᵢⱼ=0. However, if such training frameworks or ASIC accelerators for neural network training can support this type of block-wise sparsity structure, the training time and energy will decrease substantially. Proposed LSTM training has been performed using the PyTorch framework, and the code for this work is available at https://github.com/razor1179/pytorch-kaldi-CGS.

D. Design Space Exploration

There are several important design parameters for HCGS-based LSTM hardware design, including activation/weight precision, HCGS compression ratio, the number of CGS levels, and width of LSTM RNN (i.e., the number of LSTM cells in each layer).

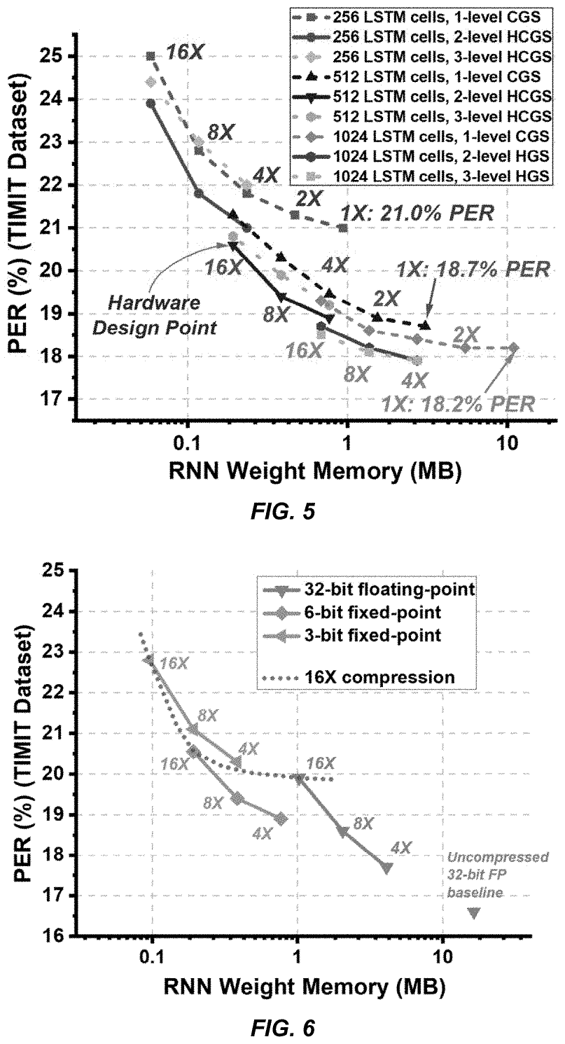

FIG. 5 is a graphical representation of HCGS design space exploration of two-layer LSTM RNNs across different RNN widths and number of CGS levels. The 6-bit weight precision and 13-bit activation precision are used for all data points. For this design space exploration, a number of different LSTM RNNs are investigated. Starting from the LSTM trained with 32-bit floating-point precision (phoneme error rate or PER=16.6% for uncompressed 512-cell LSTM), the weight precision is first reduced down to 6 bits to keep all weights on-chip with minor PER loss. With 6-bit weights, the activation precision is subsequently reduced to 13-bit, which overall resulted in small PER degradation of 2.1% (PER=18.7% for uncompressed fixed-point precision 512-cell LSTM).

FIG. 6 is a graphical representation of a weight precision investigation with HCGS-based compression for 512-cell two-layer LSTM RNNs. As illustrated in the precision study, reducing the weight precision below 6 bits (e.g., 3-bit precision) aggravated the error rate degradation for HCGS-based LSTMs compressed by 16×.

Compared with single-level CGS, the two-level HCGS scheme shows a favorable tradeoff between weight compression and PER of two-layer LSTM RNN for TIMIT data set (see FIG. 5), aided by capability to balance coarse and fine connection granularity for high levels of compression. A similar trend has been found for the three-layer LSTM RNNs for TED-LIUM and LibriSpeech data sets. Three- and four-level HCGS schemes have also been evaluated. As shown in FIG. 5, the three-level HCGS scheme resulted in 0.5%/0.2% worse PER for LSTMs with 256/512 cells and obtained marginal 0.2% PER improvement over two-level HCGS for LSTMs with 1024 cells. Four-level HCGS resulted in even worse PER results compared with three-level HCGS; hence, the four-level HCGS results were not included in FIG. 5. On the hardware side, even if three-level HCGS had shown marginally better error rate than two-level HCGS, given the additional hardware overhead of the selector and logic for additional levels of HCGS, two levels would be the optimal choice of levels for HCGS implementation.

Overall, 512-cell LSTMs show a good balance between error rate (compared with 256-cell LSTMs) and memory (compared with 1024-cell LSTMs) for various HCGS evaluations. Based on these results, the 512-cell LSTM and two-level HCGS with 16× compression are selected as the hardware design point (see FIG. 5), for speech recognition tasks using TIMIT, TED-LIUM, and LibriSpeech data sets.

E. Robustness Across Random Block Selection and Further Minimization of Index Memory

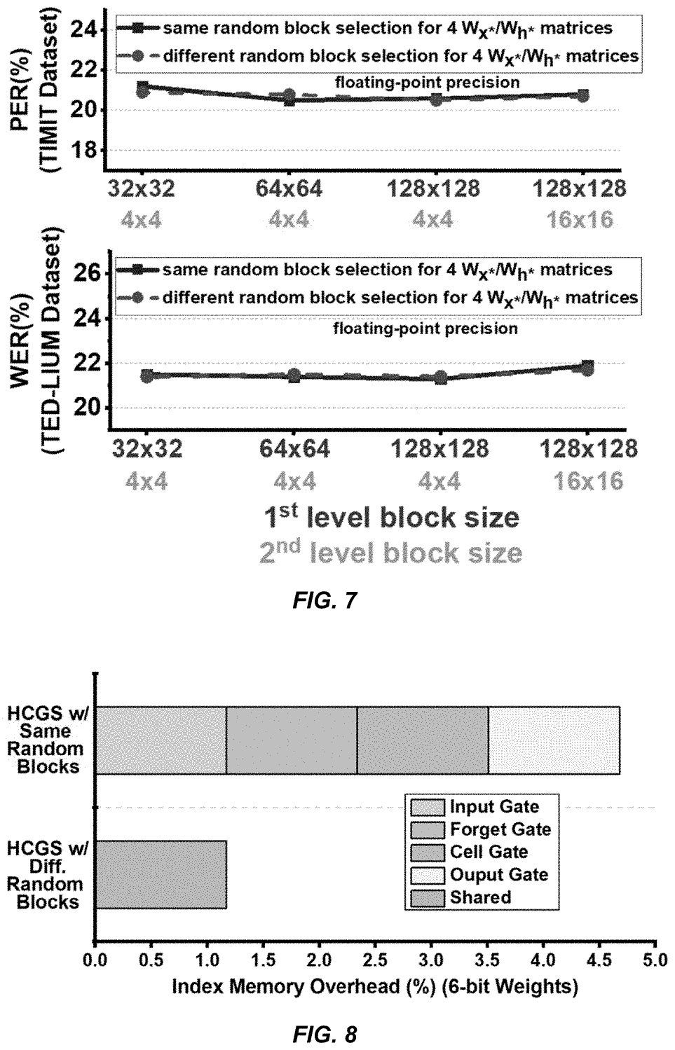

FIG. 7 is a graphical representation of robustness of HCGS performance across various block sizes and random block selection. It is important to note that the block sizes chosen in both levels may affect the final accuracy of the trained network. Therefore, LSTM networks with varying block sizes in both levels must be evaluated to obtain the optimal compression and accuracy.

FIG. 8 is a graphical representation of further reduction of index memory aided by using the same random block selection for four gates in each LSTM layer.

This shows similar PER and WER values for the cases of using the same and different random block assignments for four LSTM gates. Compared with cases of using different random block selection, sharing the same random block selection for four gates did not affect PER or WER by more than 0.2% across all LSTM evaluations.

Based on this result, to further increase the compression efficiency, the same random block selection is employed for weights associated with the four gates in each LSTM layer. As shown in FIG. 8, sharing the same random block selection results in 4× reduction of the index memory and reduces the computations for decompression by 4× as well. As a result, only 1.17% index memory overhead exists for the HCGS-based LSTM accelerator design. If the weight precision were to be reduced to 3-bit, the index memory overhead would double to 3.34%.

F. Guided Coarse-Grain Sparsity (Guided-CGS)

To benchmark the proposed pre-determined random sparsity against variants of learned sparsity methods, a guided block-wise sparsity method is introduced and called guided coarse-grain sparsity (Guided-CGS). Unlike HCGS where the blocks are chosen randomly, Guided-CGS implements a magnitude-based selection criteria to select blocks that contain the largest absolute mean weights, and the unselected blocks will be zero. The magnitude-based selection is executed after one epoch of training with group Lasso. This method ensures that the weight block selection is done through group Lasso based optimization, instead of being randomly chosen.

G. Quantizing LSTM Networks

To achieve high accuracy with very low-precision quantization, weights of the DNN are quantized during training. The in-training quantization jointly optimizes block-wise sparsity and low-precision quantization. During the forward propagation part of the LSTM training, each weight is quantized to n bits, while the backward propagation part employs full-precision weights. This way, the network is optimized to minimize the cost function with n-bit precision weights. The n-bit quantized weights are represented in Equation 10 and steps to make quantized copies of the full-precision weights are shown in Algorithm 2.

W^{q}^{ₙ}=Quantization(W,n) Equation 10

Algorithm 2 Quantization. ○ indicates
element-wise multiplication and/is
element-wise division.
Require: weights W, quantize bits n.
W ← clamp(W, −1, 1)
W^{sign} ← Sign(W)
${W}^{{q}_{n}} ← ( \frac{ceil ( abs ( W ) ∘ {2}^{n - 1} )}{{2}^{n - 1}} ) ∘ {W}^{sign}$

The parameter update section in Algorithm 1 is adapted to include the process of updating the batch normalization parameters. Back-propagation through time (BPTT) is used to compute the gradients by minimizing the cost function using the quantized weights W^{q}^{ₙ}, but the full-precision weight copies (W) are updated to ensure the network is optimized to reduce the output error for quantized weights.

III. Architecture and Design Optimizations

A. Hardware Architecture

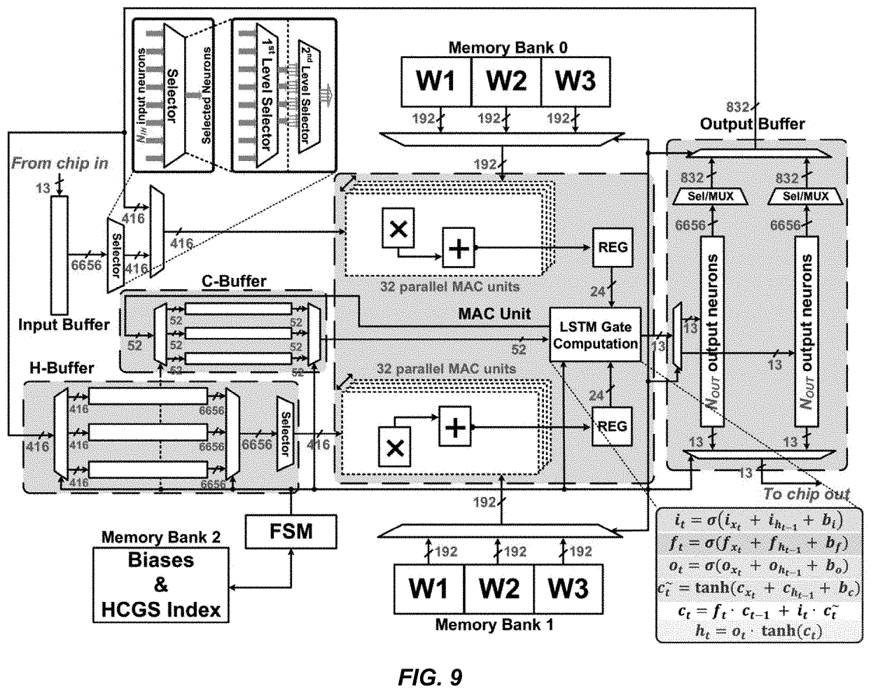

FIG. 9 is a schematic diagram of the overall architecture of the proposed LSTM accelerator. The LSTM accelerator consists of the input and output buffers, MAC unit, HCGS selector, H-buffer, C-buffer, two memory banks (144 kB each) for weight storage, bias/index memory bank (8.5 kB), and the global finite state machine (FSM). The proposed architecture facilitates the computation of one LSTM cell output per cycle after an initial latency period and reuses the MAC unit, as outputs are computed in a layer-by-layer manner. The reuse of the MAC unit leads to a compact design, allowing for storing weights, LSTM states, and configuration bits in densely packed memory structures without the need for complicated routing architectures.

1. HCGS Selector

The HCGS selector (see FIG. 9, top left) has two levels, where the first level of selector only enables the propagation of activations associated with larger non-zero weights blocks and the second level further filters through the activations associated with smaller non-zero blocks. The selection of relevant blocks is done through the implementation of block multiplexers, which allows the propagation of the set of inputs that correspond to non-zero weights stored. With 16×HCGS compression, only 32 activation outputs are required from a total of 512 activations, and only the activations corresponding to non-zero weights propagate to the MAC unit, largely improving energy efficiency.

The selection input for the HCGS selector is a 48-bit vector, where 16 bits correspond to the first level of selection, and the remaining 32 bits are used for the second level. The selector supports block sizes ranging from 128×128 to 32×32 for the first level and from 16×16 to 4×4 for the second level. This wide range of block sizes allows for flexibility to map arbitrary LSTM networks trained with HCGS onto the accelerator chip using different configurations.

2. Input and Output Buffers

An input frame consists of fMLLR features, as described in Section II-A. The input buffer is used to store the fMLLR features of an input frame, which streams in 13 bits each cycle over 512 cycles. The input buffer is essential for the continuous computation of the LSTM output as it enables the subsequent input frame to be ready for use as soon as the current frame computation is complete. This buffer ensures that there is no stall required to stream in the consecutive frames of the real-time speech input. The serial-in/parallel-out input buffer takes in 13-bit inputs sequentially and outputs all 6656 bits in parallel. The output buffer consists of two identical buffers for double buffering, which enables continuous computation of the LSTM accelerator in conjunction with the input buffer while streaming out the final layer outputs. Each output buffer employs an HCGS selector and a 6656:416 multiplexer to feedback the current layer output to the next layer. The feedback path from the output buffer to the input of the MAC facilitates the reuse of the MAC unit. Each output buffer takes in a 13-bit LSTM cell output, and the correct buffer is chosen by the FSM by keeping track of whether the buffer is full or ready to stream data out of the chip. Finally, a multiplexer is used to decide whether the xₜ input should be from the input or the output buffer, and this is done through the FSM that uses the frame complete flag to switch between the two buffers.

3. H-Buffer and C-Buffer

The H-buffer and C-buffer are rolling buffers and store the outputs of the previous frame (hₜ₋₁) and cell state (cₜ₋₁) for each LSTM layer, respectively. Each buffer has three internal registers corresponding to the maximum number of layers supported by the hardware. The C-buffer registers behave as shift registers, while the H-buffer registers operate similar to the input buffer where inputs are streamed in serially and outputs are streamed out in parallel.

4. MAC Unit

The MAC unit consists of 64 parallel MACs (computing vector-matrix multiplications) and the LSTM gate computation module (computing intermediate LSTM gate and final output values), which can perform 129 (=64×2.1) compressed operations equivalent to 2064 (=129×16) uncompressed operations effectively in each cycle, aided by the proposed HCGS compression by 16×. The non-linear activation functions of sigmoid and hyperbolic tangent (tanh) are implemented with piecewise linear (PWL) modules using 20 linear segments that exhibit maximum relative error [(PWL_output−ideal_output)/ideal_output] of 1.67×10⁻³ and average relative error of 3.30×10⁻⁴.

5. Weight/Bias Memory

As described in Section III-B, weights are stored in the interleaved fashion, where each memory sub-bank (W1-W3) stores weights corresponding to a single layer. Since all weights of the two-/three-layer RNNs can be loaded on-chip initially, write operations are not needed for the LSTM accelerator during inference operations. The required read bandwidth of the LSTM accelerator is 192 bits/cycle from memory bank 0 and 192 bits/cycle from memory bank 1 (see FIG. 9). If there are more parallel MAC units, the required read bandwidth will proportionally increase.

The memory sub-banks that store weights of layers not currently being computed are put into “selective precharge” mode, which clamps the wordlines to a low value (0 V) and floats the bitlines for leakage power reduction. Getting into and out of this selective precharge mode each adds a small overhead of one extra cycle. Moreover, due to the nature of the LSTM, each weight in the memory and sub-banks are used only once, which makes the number of transitions between selective precharge mode and normal mode for each sub-bank to be minimal. Overall, adding the selective precharge mode resulted in 19% energy-efficiency improvement at the system-level for the LSTM accelerator.

B. Interleaved Memory Storage

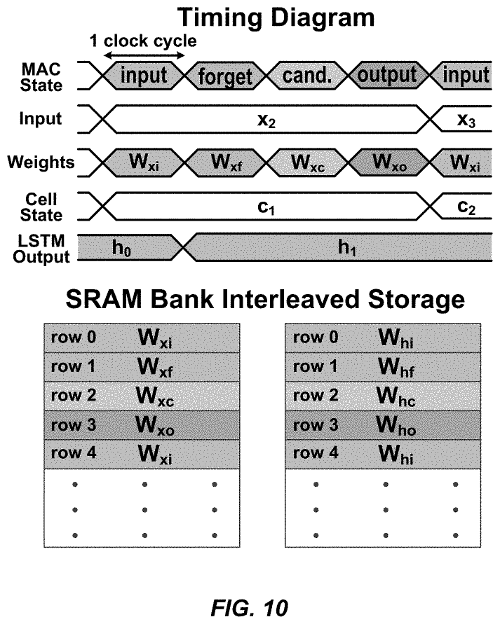

FIG. 10 illustrates a timing diagram of LSTM computation and the necessary interleaved storage pattern of weights in on-chip SRAMs. The LSTM cell stores the intermediate products to compute the cell state (cₜ) and output (hₜ). Conventionally, the cell states and outputs of an entire layer are computed only after every intermediate gate output for the corresponding layer is completed. However, this leads to additional memory requirements to store the intermediate gate outputs for all the LSTM cells in the layer. To alleviate this issue, embodiments take advantage of the structure of the LSTM cell. The proposed architecture cycles between the four states computing internal gates of the LSTM cell, namely, input gate (iₜ), forget gate (ƒₜ), output gate (oₜ), and candidate memory (\tilde{c}ₜ). In addition, the vector-matrix multiplications of xₜWₓ, and hₜ₋₁W_{h*} can be computed in independent streams, effectively increasing throughput via parallel computing.

To enable this efficiently, each row of four matrices Wₓᵢ, W_{xƒ}, Wₓₒ, and W_{xc} is stored in a staggered manner (same for W_{h*}) in on-chip SRAM arrays (see FIG. 10, right bottom). This way, the computation of new cₜ and hₜ values can be completed after every four cycles, hence eliminating the requirement to store all intermediate gate outputs of the layer. Also, as described in Section II-E, since the same random hierarchical block selection is used for HCGS for all four matrices of Wₓᵢ, W_{xƒ}, Wₓₒ, and Wₓ, (same for W_{h*}), the selector logic does not need to change through the interleaving process.

C. End-to-End Operation and Latency

Since all weights of target LSTM networks with HCGS compression are stored on-chip, there is no need to off-chip DRAM communication, and the chip performs the end-to-end operation of the entire LSTM in a pipelined fashion. The initial delay of 512 cycles is consumed to load the input buffer. Once the input buffer is filled, each LSTM state computation takes three cycles, one for MAC, one for addition, and one for activation, which is all pipelined. The first neuron output takes a total of nine cycles, after which a new neuron output is obtained every cycle. The outputs of the current layer are stored in the output buffer. Once the output buffer is full, if the current layer is an intermediate layer, the output directly is conveyed to the input of the next layer, or if the current layer is the last layer of the LSTM, the output data is streamed out of the chip over 512 cycles.

D. Computing Device

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art. Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

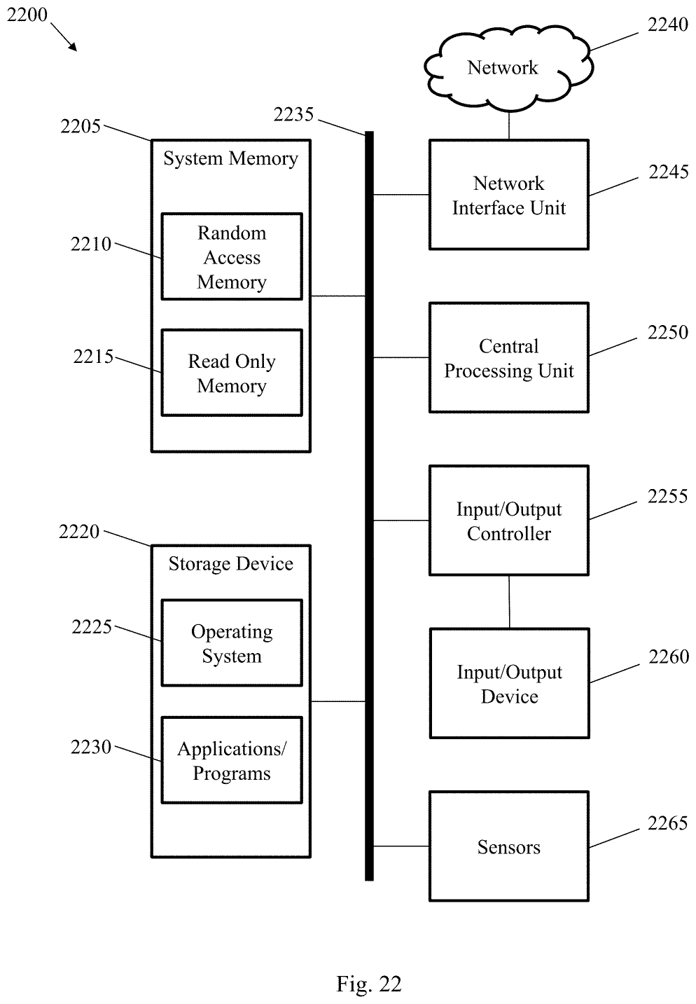

FIG. 22 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 22 depicts an illustrative computer architecture for a computer 2200 for practicing the various embodiments of the invention. The computer architecture shown in FIG. 22 illustrates a conventional personal computer, including a central processing unit 2250 (“CPU”), a system memory 2205, including a random access memory 2210 (“RAM”) and a read-only memory (“ROM”) 2215, and a system bus 2235 that couples the system memory 2205 to the CPU 2250. A basic input/output system containing the basic routines that help to transfer information between elements within the computer, such as during startup, is stored in the ROM 2215. The computer 2200 further includes a storage device 2220 for storing an operating system 2225, application/program 2230, and data. The storage device 2220 is connected to the CPU 2250 through a storage controller (not shown) connected to the bus 2235. The storage device 2220 and its associated computer-readable media provide non-volatile storage for the computer 2200. Although the description of computer-readable media contained herein refers to a storage device, such as a hard disk or CD-ROM drive, it should be appreciated by those skilled in the art that computer-readable media can be any available media that can be accessed by the computer 2200.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 2200 may operate in a networked environment using logical connections to remote computers through a network 2240, such as TCP/IP network such as the Internet or an intranet. The computer 2200 may connect to the network 2240 through a network interface unit 2245 connected to the bus 2235. It should be appreciated that the network interface unit 2245 may also be utilized to connect to other types of networks and remote computer systems.

The computer 2200 may also include an input/output controller 2255 for receiving and processing input from a number of input/output devices 2260, including a keyboard, a mouse, a touchscreen, a camera, a microphone, a controller, a joystick, or other type of input device. Similarly, the input/output controller 2255 may provide output to a display screen, a printer, a speaker, or other type of output device. The computer 2200 can connect to the input/output device 2260 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above, a number of program modules and data files may be stored in the storage device 2220 and/or RAM 2210 of the computer 2200, including an operating system 2225 suitable for controlling the operation of a networked computer. The storage device 2220 and RAM 2210 may also store one or more applications/programs 2230. In particular, the storage device 2220 and RAM 2210 may store an application/program 2230 for providing a variety of functionalities to a user. For instance, the application/program 2230 may comprise many types of programs such as a word processing application, a spreadsheet application, a desktop publishing application, a database application, a gaming application, internet browsing application, electronic mail application, messaging application, and the like. According to an embodiment of the present invention, the application/program 2230 comprises a multiple functionality software application for providing word processing functionality, slide presentation functionality, spreadsheet functionality, database functionality and the like.

The computer 2200 in some embodiments can include a variety of sensors 2265 for monitoring the environment surrounding and the environment internal to the computer 2200. These sensors 2265 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

IV. Evaluation Results

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the system and method of the present invention. The following working examples therefore, specifically point out the exemplary embodiments of the present invention, and are not to be construed as limiting in any way the remainder of the disclosure.

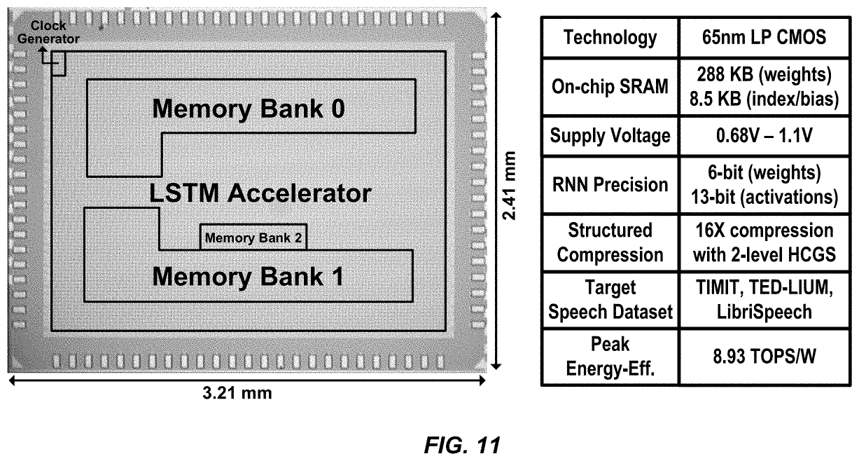

FIG. 11 illustrates a chip micrograph of an evaluated embodiment along with a performance summary. The proposed LSTM RNN accelerator is fabricated in 65-nm LP CMOS. For chip testing, the weights, biases, and configuration bits are initially loaded to on-chip memory. To verify real-time operation, 13-bit input fMLLR features are streamed into the input buffer every cycle (see Section III-A), while LSTM outputs from the chip are streamed out and stored.

A. Pre-/Post-Processing Operations

The pre-processing steps are performed in Kaldi framework using audio files from TIMIT, TED-LIUM, and LibriSpeech data sets. The same extracted input features were used for LSTM training and real-time inference based on HCGS compression. With LSTM outputs streamed out of the chip, post-processing is also performed using Kaldi framework to obtain the final error rates for speech recognition. When 512 outputs (13-bit each) per frame are received from chip output, the hidden Markov model (HMM) states are calculated using a weighted finite-state transducer (WFST) that performs Viterbi beam search, finally obtaining phoneme error rate (for TIMIT data set) or WER (for TED-LIUM/LibriSpeech data sets).

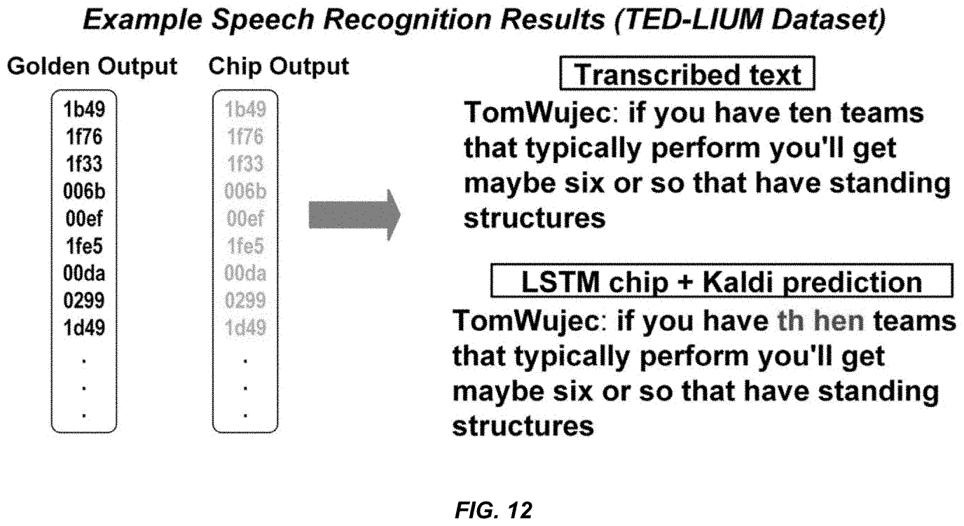

FIG. 12 illustrates example speech recognition results and the transcribed text for the TED-LIUM data set. While the chip did not integrate pre-/post-processing engines, the relative power consumption of them can be deduced from other prior works. Regarding pre-processing, a recent work proposed serial FFT computation and frame computation re-use for MFCC and reported the MFCC pre-processing power from 28-nm prototype chip as 340 nW at 0.41 V at 40 kHz. Even if CMOS scaling is considered from different technologies, supply voltage, and frequency, the MFCC pre-processing power will be a fraction of 1 mW for real-time speech recognition. Regarding post-processing, another work implemented both the deep neural network (only supported MLPs) and post-processing engine (Viterbi search) for speech recognition. For large MLPs (e.g., six layers of 512 neurons each), it has been reported that the MLP module consumes >4× more power than the WFST/Viterbi search module. As aforementioned, an LSTM RNN requires 8× weights compared with an MLP with the same number of neurons per layer. Therefore, both the pre-processing and post-processing engines will consume relatively much smaller power than the LSTM RNN engine, and thus, power/energy reduction of the LSTM RNN would remain as a large benefit for the overall ASR system.

B. Performance, Energy, and Error Rate Measurements

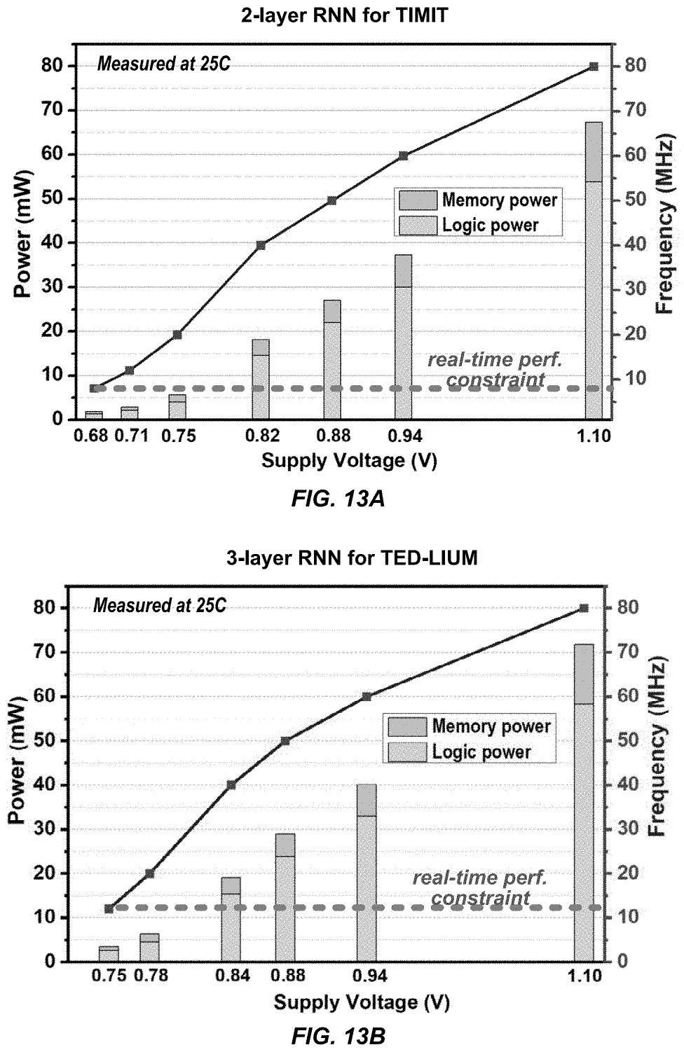

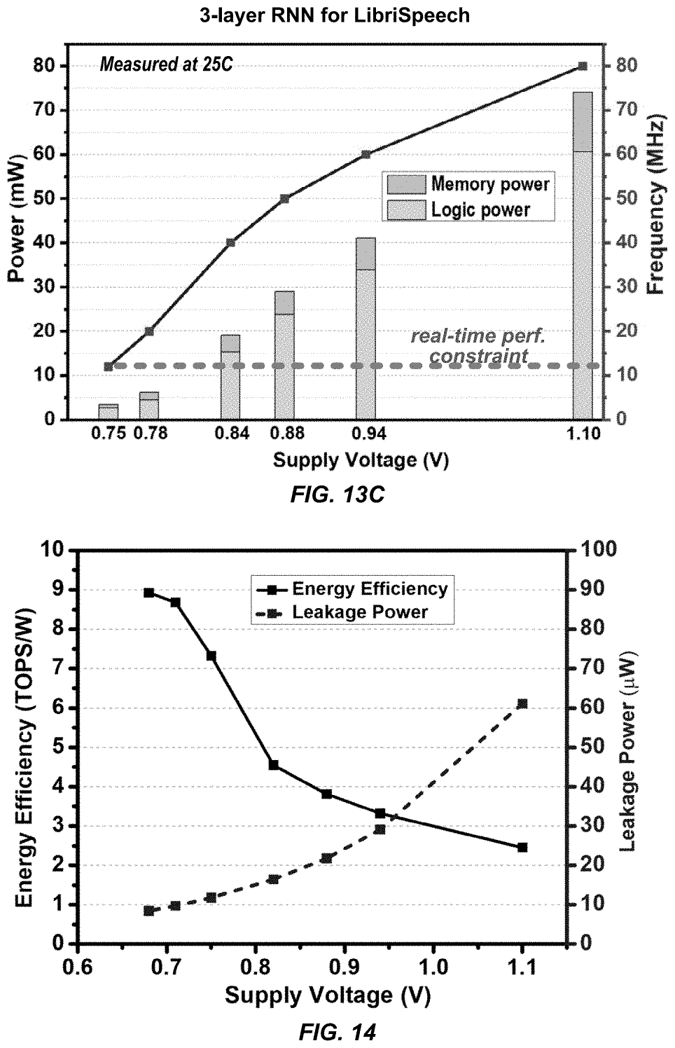

FIG. 13A is a graphical representation of power and frequency measurement results with voltage scaling for two-layer LSTM for the TIMIT data set. FIG. 13B is a graphical representation of power and frequency measurement results with voltage scaling for three-layer LSTM for the TED-LIUM data set. FIG. 13C is a graphical representation of power and frequency measurement results with voltage scaling for three-layer LSTM for the LibriSpeech data set. With voltage scaling, the power consumption at 0.68 V for the two-layer RNN for TIMIT is 1.85 mW at 8 MHz (see FIG. 13A) and, at 0.75 V for the three-layer RNNs for TED-LIUM/LibriSpeech, is 3.43/3.42 mW at 12 MHz (see FIGS. 13B and 13C). In all cases, the accelerator satisfies the real-time speech recognition requirement of 100 frames/s (10 ms/frame).

FIG. 14 is a graphical representation of measurement results of energy efficiency (TOPS/W) and leakage power of two-layer LSTM for TIMIT data set. With the proposed HCGS scheme, the LSTM accelerator achieves an average energy efficiency of 8.93 TOPS/W for running end-to-end two-layer LSTM RNN for TIMIT data set and 7.22/7.24 TOPS/W for running end-to-end three-layer LSTM RNNs for TED-LIUM/LibriSpeech data sets while meeting the real-time speech recognition requirement. If the real-time performance constraint is relaxed, higher energy efficiency can be achieved. The total leakage power at 0.68-V supply is less than 10 ρW (see FIG. 14).

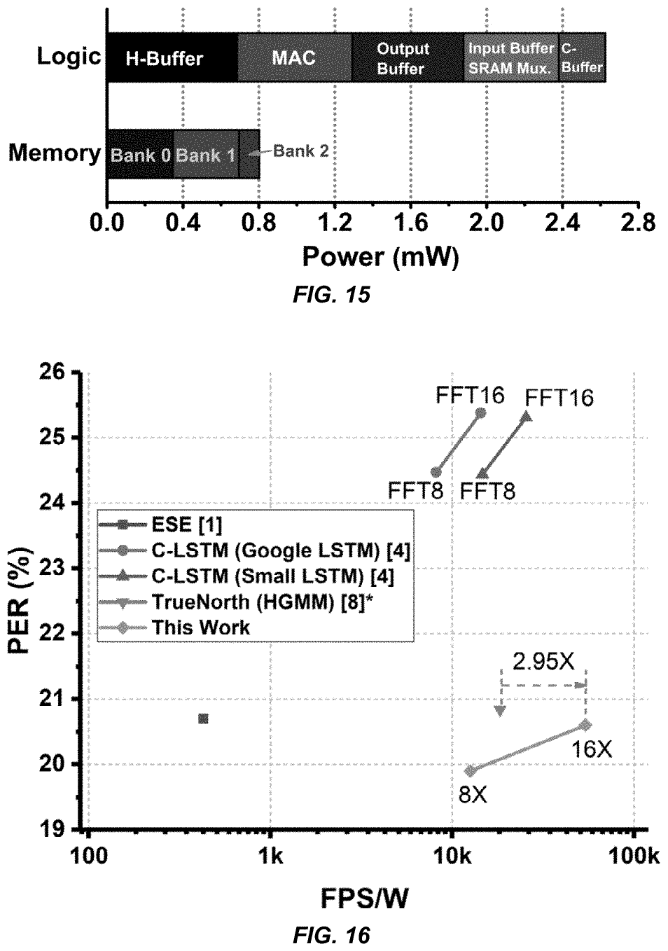

FIG. 15 is a graphical representation of the memory and logic power breakdown for the three-layer RNN at 0.75-V supply. It can be seen that the logic power is dominant due to the highly compressed weight memory despite a large number of RNN weight matrices. Pipelined with the LSTM gate computation unit, the MAC engines exhibit a very high utilization ratio of 99.66%.

This high MAC efficiency is obtained because each of the layers in the two-/three-layer target RNNs has a regular structure to start with, and also HCGS compression still maintains a regular structure because the same number of blocks are pruned/kept in the same block row (see FIG. 3). As long as the number of compressed LSTM operations for each RNN layer is an integer multiple of 64, all 64 MAC units in the chip will continuously perform operations without idle periods. In addition, the input and output buffers (see FIG. 9) are designed specifically to enable continuous operations without idle periods between layers.

Measured accuracy results of 20.6% PER are achieved for TIMIT, 21.3% WER for TED-LIUM, and 11.4% WER for LibriSpeech data sets.

C. Comparison to Prior LSTM/RNN Works

FIG. 16 is a graphical representation comparing the TIMIT PER and frames/second/power (FPS/W) of the proposed HCGS and prior works that perform speech/phoneme recognition. The RNN accelerator reports low power consumption but can only support limited keyword spotting tasks and is not considered. Compared with 28-nm ASIC design supporting speech recognition, this work shows 2.95× higher energy efficiency (FPS/W) with slightly better PER. Although FPS/W in [10] (S. Wang et al., “C-LSTM: Enabling efficient LSTM using structured compression techniques on FPGAs,” in Proc. ACM/SIGDA Int. Symp. Field-Program. Gate Arrays, February 2018, pp. 11-20) is comparable, embodiments described herein achieve considerably lower PER. Conversely, [7] (S. Han et al., “ESE: Efficient speech recognition engine with sparse LSTM on FPGA,” in Proc. ACM/SIGDA Int. Symp. Field-Program. Gate Arrays (FPGA), 2017, pp. 75-84) has comparable PER but poor FPS/W. The recent ASIC work based on block-circulant matrices [11] (J. Yue et al., “A 65 nm 0.39-to-140.3 TOPS/W 1-to-12b unified neural network processor using block-circulant-enabled transpose-domain acceleration with 8.1× higher TOPS/mm2 and 6T HBSTTRAM-based 2D data-reuse architecture,” in IEEE ISSCC Dig. Tech. Papers, February 2019, pp. 138-140) has neither reported the absolute PER for TIMIT nor the results necessary to calculate corresponding FPS/W. Overall, this demonstrates the effectiveness of the proposed design due to the algorithm-hardware co-optimization.

Table I shows a detailed comparison with prior ASIC and FPGA hardware designs for RNNs. Compared with the RNN ASIC works of [12] (F. Conti, L. Cavigelli, G. Paulin, I. Susmelj, and L. Benini, “Chipmunk: A systolically scalable 0.9 mm2, 3.08 Gop/s/mW 1.2 mW accelerator for near-sensor recurrent neural network inference,” in Proc. IEEE Custom Integr. Circuits Conf. (CICC), April 2018, pp. 1-4) and [13] (S. Yin et al., “A 1.06-to-5.09 TOPS/W reconfigurable hybrid-neural-network processor for deep learning applications,” in Proc. Symp. VLSI Circuits, June 2017, pp. 26-27), this work shows 2.90× and 1.75× higher energy efficiency (TOPS/W), respectively. Reference [11] (J. Yue et al., “A 65 nm 0.39-to-140.3 TOPS/W 1-to-12b unified neural network processor using block-circulant-enabled transpose-domain acceleration with 8.1× higher TOPS/mm2 and 6T HBSTTRAM-based 2D data-reuse architecture,” in IEEE ISSCC Dig. Tech. Papers, February 2019, pp. 138-140) presented higher TOPS/W, but the end-to-end latency or FPS was not reported. Moreover, only a simpler TIMIT data set has been benchmarked (while embodiments described herein are also benchmarked against more complex TED-LIUM and LibriSpeech data sets), and the absolute TIMIT PER has not been shown.

TABLE I
COMPARISON OF RNN PERFORMANCE WITH PRIOR WORKS

| | [7] | [10] | [12] | [13] | [11] | This Work |
|---|---|---|---|---|---|---|
| Technology | FPGA | FPGA | 65 nm | 65 nm | 65 nm | 65 nm |
| | | | CMOS | CMOS | CMOS | CMOS |
| Area (mm²) | — | — | 1.57 | 19.36 | 7.5 | 7.74 |
| On-Chip | 4.2 MB | 280 | 82 | 348 | 100 | 297 |
| Memory (KB) | | | | | | |
| Number of MACs | — | — | 96 | — | 256 | 65 |
| Bit-Precision | 12/16 | 16/16 | 8/16 | 16/16 | 4/4 | 6/13 |
| Weights/Activations | | | | | (FFT: 8-bit) | |
| Core Voltage (V) | — | — | 1.24/0.75 | 1.2/0.67 | 1.15/0.54 | 1.1/0.68 |
| Frequency (MHz) ¹ | 200 | 200 | 168/20 | 200/10 | 200/25 | 80/8 |
| Power (mW) ¹ | 41 W | 22 W | 29/1.2 | 447/4 | 339.2/13.3 | 67.3/1.85 |
| Peak Performance | 2500 | — | — | — | 14.9 | 164.95/24.60 |
| (GOPS) ¹ | | | | | | |
| Energy-Efficiency | 0.061 | 2.08 | 1.11/3.08 | 1.06/5.09 | 14.4 q | 2.45/8.93 |
| (TOPS/W) ¹ | | | | | | |
| PER (TIMIT) | 20.7% | 25.3% | — | — | worse by 1.93% | 20.6% |
| | | | | | compared | (measured) |
| | | | | | to baseline | |
| WER (TED-LIUM) | — | — | — | — | | 21.3% |
| | | | | | | (measured) |
| WER (LibriSpeech) | — | — | — | — | | 11.4% |
| | | | | | | (measured) |

D. Speech Recognition Evaluation Setup

For the speech recognition tasks, the input consists of 440 feature space maximum likelihood linear regression (fMLLR) features that are extracted using the s5 recipe of Kaldi. The fMLLR features were computed using a time window of 25 ms with an overlap of 10 ms. The PyTorch-Kaldi speech recognition toolkit is used to train the LSTM networks. The final LSTM layer generates the acoustic posterior probabilities, which are normalized by their prior and then conveyed to a hidden Markov model (HMM) based decoder. An n-gram language model derived from the language probabilities is merged with the acoustic scores by the decoder. A beam search algorithm is then used to retrieve the sequence of words uttered in the speech signal. The final error rates for TIMIT and TED-LIUM corpora are computed with the NIST SCTK scoring toolkit.

For TIMIT, the phoneme recognition task (aligned with the Kaldi s5 recipe) is considered, and 2-layer unidirectional LSTMs are trained, with 256, 512, and 1,024 cells per layer. For TED-LIUM, the word recognition task (aligned with the Kaldi s5 recipe) is targeted, 3-layer uni-directional LSTMs are trained, with 256, 512, and 1,024 cells per layer. All possible combinations of power-of-2 block sizes are evaluated, and the PER for TIMIT and WER for TED-LIUM were relatively constant, showing the robustness of HCGS across different block sizes.

E. Improvements Due to HCGS

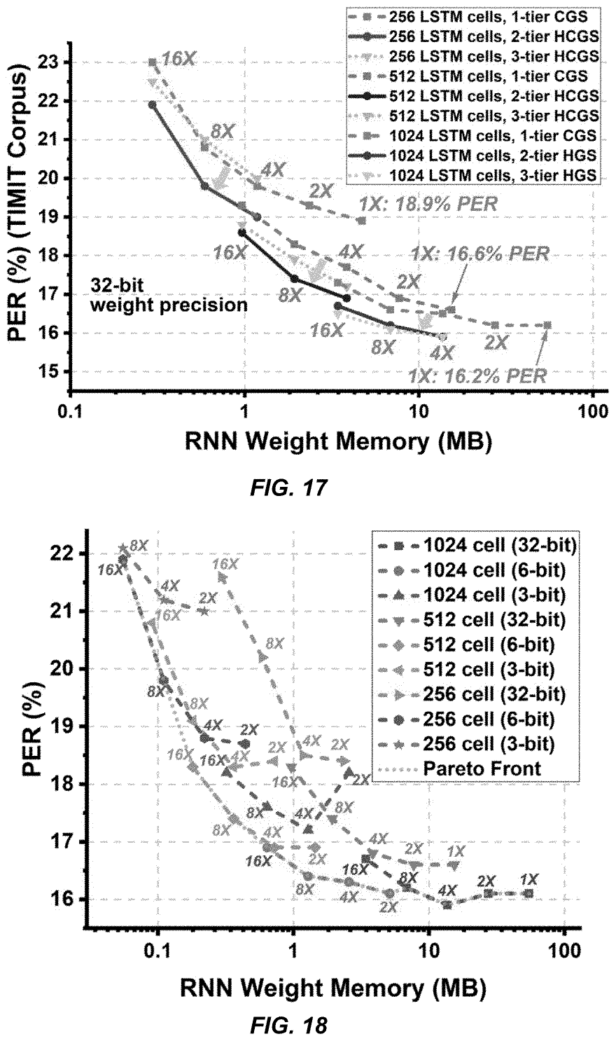

FIG. 17 is a graphical representation comparing PER (TIMIT) between the multi-tier HCGS scheme and a single-tier CGS scheme. Improvements in error rates are observed when LSTMs are trained with HCGS due to the hierarchical structure. The results for LSTMs with 32-bit weight precision for different number of cells (256, 512, and 1,024) and compression rates (1× to 16×) are shown. In all evaluations, LSTM networks trained with two-tier HCGS achieve noticeably lower PER than single-tier CGS for the same target compression. The three-tier HCGS shows marginal PER improvement over two-tier HCGS for LSTMs with 1,024 cells, but worse PER for LSTMs with 256 and 512 cells. Four-tier HCGS resulted in worse PER results compared to three-tier HCGS, hence was not included in FIG. 17.

The hierarchical sparsity leads to the improved accuracy of the networks. Sparse weights with fine granularity tend to form a uniform sparsity distribution even within smaller regions of the weight matrix. This property will lead to extremely sporadic and isolated connections when the target compression rate is high. However, the grouping of sparse weights within the hierarchical structure of HCGS allows densely connected regions to be formed even when the target compression rate is high. As two-tier HCGS outperforms single-tier CGS in terms of accuracy and three-tier HCGS leads to marginal/worse performance than two-tier HCGS, the reported results in Sections IV-F and IV-G focus on LSTM training with two-tier HCGS.

F. LSTM Results for TIMIT

FIG. 18 is a graphical representation of PER vs. RNN weight memory results for various 2-layer LSTMs for TIMIT. For the TIMIT corpus, 2-layer LSTMs are trained for a number of different LSTM cells (256, 512 and 1,024), compression rates (2×, 4×, 8× and 16×) and weight quantization schemes (32-bit, 6-bit and 3-bit). For a similar memory footprint, wider sparse networks perform better than narrower dense networks. For example, a 1,024-cell network with 8× compression shows a lower PER than a 512-cell network with 2× compression. The Pareto front curve in FIG. 18 offers the lowest PER for the smallest memory in the search space.

G. LSTM Results for TED-LIUM

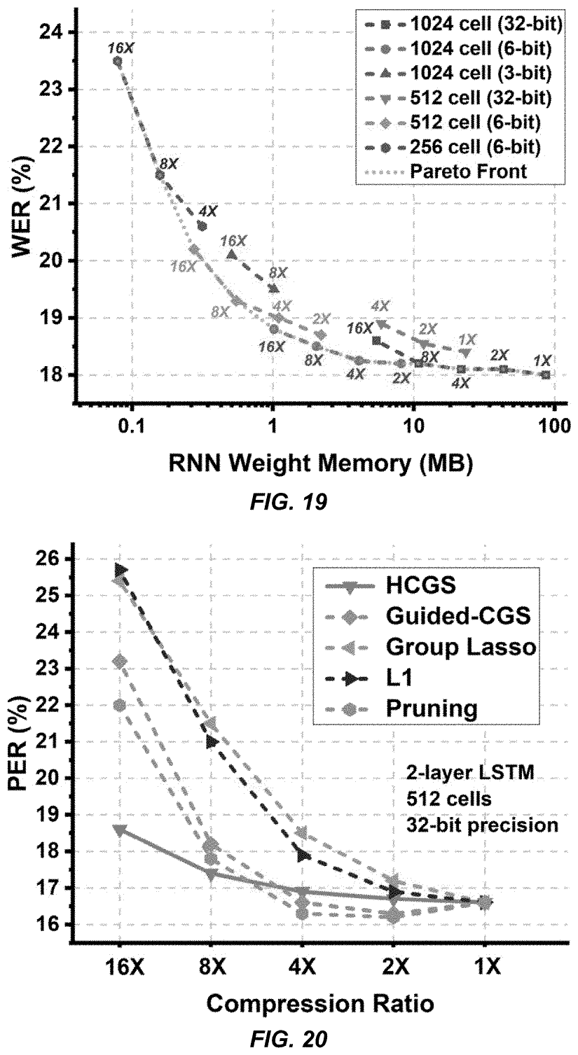

FIG. 19 is a graphical representation of WER vs. RNN weight memory results for various 3-layer LSTMs for TED-LIUM. For the TED-LIUM corpus, 3-layer LSTMs are trained for a number of different LSTM cells (256, 512 and 1,024), compression rates (2×, 4×, 8× and 16×) and weight precision schemes (32-bit, 6-bit and 3-bit). Similar to FIG. 18, a 1,024-cell network with 8× compression results in a lower WER than a 512-cell network with 2× compression. The Pareto front curve is extracted and shown in FIG. 19.

A prior work reported that wider CNNs can lower the precision of activations/weights than shallower counterparts, for the same or even better accuracy. However, evaluations of embodiments described herein do not result in such trends with LSTMs for TIMIT or TED-LIUM. Especially when combined with structured compression, LSTMs are more sensitive to low-precision quantization, so that LSTMs with medium (e.g. 6-bit) precision show the best trade-off between PER/WER and weight memory compression.

H. Comparison with Learned Sparsity and Prior Works

FIG. 20 is a graphical representation of a PER (TIMIT) comparison between HCGS and learned sparsity methods. For comprehensive comparison, learned sparsity methods of Guided-CGS (Section II-F), group Lasso, L1 normalization, and magnitude-based pruning (MP) are implemented. To obtain block-wise sparsity for group Lasso scheme, block sizes similar to that of single-tier CGS are chosen. The sparsity for group Lasso and L1 schemes are obtained through a final pruning operation conducted after training. For every scheme, the same sparsity is applied for all weight matrices (32-bit precision) in 2-layer 512-cell LSTMs.

Single-tier Guided-CGS shows better PER than HCGS for compression ratios up to 4×, but PER worsens substantially for larger compression ratios. This sharp increase in PER is observed for group Lasso, L1 and MP schemes as well, which can be attributed to the congestion of selected groups in small regions of weight matrices caused by the regularization function. The pre-determined random sparsity in HCGS ensures that congestion is avoided when selecting blocks within weight matrices, resulting in a much more graceful PER degradation for large (>4×) compression ratios. The effectiveness of random pruning was also demonstrated, where the pruned DNN recovered the accuracy loss by fine-tuning the remaining weights.

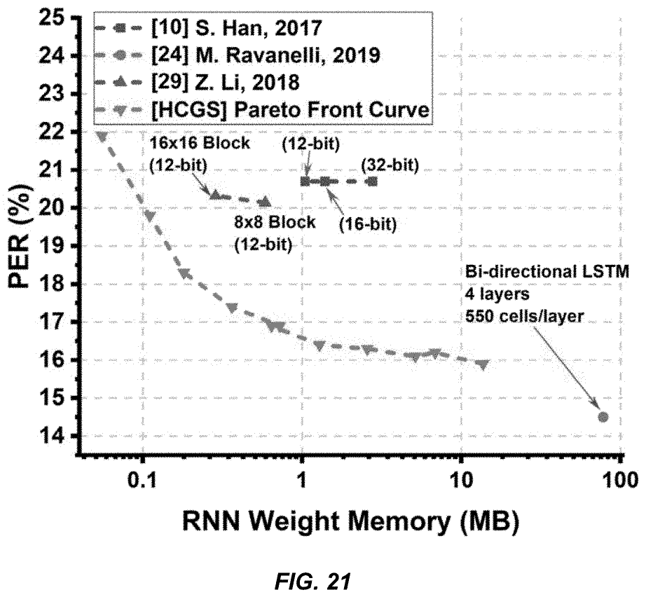

FIG. 21 compares the total RNN weight memory and PER for prior LSTM works with structured compression [10] (S. Han, J. Kang, H. Mao, Y. Hu, X. Li, Y. Li, D. Xie, H. Luo, S. Yao, Y. Wang et al., “ESE: Efficient speech recognition engine with sparse LSTM on FPGA,” in Proceedings of the ACM/SIGDA International Symposium on Field-Programmable Gate Arrays (FPGA), 2017, pp. 75-84), [29] (Z. Li, S. Wang, C. Ding, Q. Qiu, Y. Wang, and Y. Liang, “Efficient recurrent neural networks using structured matrices in FPGAs,” in Proceedings of the International Conference on Learning Representations (ICLR), Workshop Track, 2018) and a baseline uncompressed LSTM [24] (M. Ravanelli, T. Parcollet, and Y. Bengio, “The PyTorch-Kaldi speech recognition toolkit,” in IEEE International Conference on Acoustics, Speech and Signal Processing (ICASSP), 2019, pp. 6465-6469), with the Pareto front curve obtained with the proposed HCGS-based LSTMs. It can be seen that the datapoints in the Pareto front of HCGS provide lower PER while requiring less storage for the LSTM weights.

Those skilled in the art will recognize improvements and modifications to the preferred embodiments of the present disclosure. All such improvements and modifications are considered within the scope of the concepts disclosed herein and the claims that follow.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A neural network accelerator, comprising:
an input buffer;
an output buffer; and
a hierarchical coarse-grain sparsity (HCGS) selector configured to randomly select block-wise weights from the input buffer for training a neural network.

2. The neural network accelerator of claim 1, wherein the neural network is a long short-term memory (LSTM).

3. The neural network accelerator of claim 1, wherein the neural network is a recurrent neural network (RNN).

4. The neural network accelerator of claim 1, wherein the weights are stored on-chip.

5. The neural network accelerator of claim 4, wherein greater than 50% of the weights are stored on-chip.

6. The neural network accelerator of claim 1, further comprising an HCGS hierarchy having at least one level of weight compression.

7. The neural network accelerator of claim 6, further comprising an HCGS hierarchy having more than one level of compression.

8. The neural network of claim 1, wherein the HGSC selector is configured for block-wise sparsity.

9. The neural network accelerator of claim 1, wherein the HCGS selector is configured for low-precision quantization.

10. The neural network accelerator of claim 1, wherein the neural network is trained for on-device automatic speech recognition (ASR).

11. A method for compressing a neural network, the method comprising:
randomly selecting a hierarchical structure of block-wise weights in the neural network; and
training the neural network by selecting a same number of random blocks for every block row.

12. The method of claim 11, further comprising accelerating the neural network on an application-specific integrated circuit (ASIC).

13. The method of claim 11, further comprising the step of storing the weights on-chip.

14. The method of claim 13, wherein greater than 50% of the weights are stored on-chip.

15. The method of claim 11, further comprising the step of compressing the weights at least once.

16. The method of claim 15, further comprising the step of compressing the weights more than once.

17. The method of claim 17, further comprising the step of recursively selecting smaller block sizes for each subsequent compression.

18. The method of claim 11, further comprising the step of compressing weights a first time using a first block size, and compressing weights a second time using a second block size.

19. The method of claim 18, wherein the first block size is larger than the second block size.

20. The method of claim 11, further comprising the step of low precision quantization of the block-wise weights.
